(19) United States
(12) Patent Application Publication
(10) Pub. No.: US 2008/0249254 A1
(43) Pub. Date: Oct. 9, 2008

(54) Process for chlorosulfonating polyolefins

(76) Inventor: Royce Elton Ennis, Silsbee, TX (US)

Correspondence Address: DUPONT PERFORMANCE ELASTOMERS L.L.C., PATENT RECORDS CENTER, 4417 LANCASTER PIKE, BARLEY MILL PLAZA P25, WILMINGTON, DE, 19805, US

(21) Appl. No.: 12/075,770

(22) Filed: Mar. 13, 2008

Related U.S. Application Data
(60) Provisional application No. 60/921,654, filed on Apr. 3, 2007.

(51) Int. Cl. C08F 8/38

(52) U.S. Cl. 525/333.9

(57) ABSTRACT

Chlorosulfonated polyolefin elastomers containing 0.5-10 weight percent chlorine and 0.25 to 5 weight percent sulfur are prepared in a low temperature (50° to 75° C.) solution process employing a chlorosulfonation agent of sulfuryl chloride or the combination of Cl₂ and SO₂.

### CROSS-REFERENCE TO RELATED APPLICATIONS

This application claims the benefit of U.S. Provisional Application No. 60/921,654 filed Apr. 3, 2007.

### FIELD OF THE INVENTION

This invention relates to a process for chlorosulfonating polyolefins, more particularly to a process for manufacturing chlorosulfonated polyolefins comprising 0.5 to 10 weight percent chlorine and 0.25 to 5 weight percent sulfur.

### BACKGROUND OF THE INVENTION

Chlorosulfonated polyethylene elastomers and chlorosulfonated ethylene copolymer elastomers have been found to be very good elastomeric materials for use in applications such as wire and cable jacketing, molded goods, automotive hose, power transmission belts, roofing membranes and tank liners. These materials are noted for their balance of oil resistance, thermal stability, ozone resistance and chemical resistance.

Historically, a wide variety of polyolefin polymers, including ethylene and propylene homopolymers and copolymers, have been utilized as the starting polymers (i.e. “base polymers” or “base resins”) for manufacture of chlorosulfonated products. The majority of base polymers employed in the manufacture of chlorosulfonated elastomers have been polyethylene types, e.g. low density polyethylene (LDPE), linear low density polyethylene (LLDPE) and high density polyethylene (HDPE). Most of the ethylene homopolymers and copolymers employed to make these elastomers are polymerized by a high pressure free radical catalyzed process or by a low pressure process using Ziegler-Natta or Phillips type catalysts. Recently, LLDPE made by single site or metallocene catalysts have become readily available.

Most commercial chlorosulfonated polyolefins contain between 20 and 50 weight percent chlorine and between 0.15 and 1.5 weight percent sulfur. They are typically made in a high temperature (i.e. >110° C.) process.

Ethylene based elastomers (e.g. EP and EPDM) are utilized as viscosity modifiers for oils in automotive and industrial applications. These polymers are readily soluble and stable in paraffinic and napthenic oils whereas more polar polymers (e.g. ethylene acrylic or methacrylic copolymers and highly chlorinated ethylene polymers) are not. Some of these oil additive polymers are also functionalized with reactive groups in order to incorporate stabilizers for formulated oil systems having enhanced stability.

It would be desirable to have chlorosulfonated ethylene/alpha-olefin copolymers having less than 10 weight percent chlorine and a low level of residual crystallinity for use in oil based solutions. In some of these applications where solution viscosity must be balanced with oil solubility and polymer thermal stability, it would be desirable to employ copolymers manufactured with a single site catalyst to alleviate the low level of highly crystalline material normally present in traditional LLDPE materials.

It would be desirable to have chlorosulfonated polyolefins comprising 0.5 to 10 weight percent (wt. %) chlorine and 0.25 to 5 wt. % sulfur to take advantage of their oil solubility and reactive sulfonyl chloride groups in these special applications. Such polymers have been made (U.S. Pat. No. 3,624,054, U.S. Pat. No. 4,560,731 and EP 131948 A2) by gas phase processes. These processes suffer from the disadvantage of requiring polymers having high levels of crystallinity.

It would be desirable to have a low temperature solution phase process for the manufacture of chlorosulfonated polyolefins having low levels of chlorine and sulfur. Such a process would allow the production of chlorosulfonated products having low or no crystallinity and having the combination of low chlorine and moderate to high sulfur levels that are not generally obtainable via the typical high temperature solution chlorosulfonation process.

### SUMMARY OF THE INVENTION

An aspect of the present invention is a process for the manufacture of chlorosulfonated polyolefins comprising 0.5 to 10 weight percent chlorine and 0.25 to 5 weight percent sulfur, said process comprising:

A) dissolving at least one polyolefin base polymer in a solvent at a temperature between 50° and 100° C. to form a solution;

B) adjusting the temperature of the solution to between 50° and 75° C. without precipitating said polyolefin; and

C) adding a chlorosulfonation agent and initiator to said solution, while maintaining said temperature between 50° and 75° C. to form at least one chlorosulfonated polyolefin comprising 0.5 to 10 weight percent chlorine and 0.25 to 5 weight percent sulfur.

### DETAILED DESCRIPTION OF THE INVENTION

The chlorosulfonated polyolefins made by the process of this invention contain between 0.5 and 10 (preferably between 0.75 and 8, most preferably between 1 and 5) weight percent chlorine and between 0.25 and 5 (preferably between 0.35 and 3, most preferably between 0.5 and 2) weight percent sulfur. These copolymers are made in a solution process (meaning that the polyolefin base polymer is dissolved in a solvent) by reaction with a chlorosulfonation agent selected from the group consisting of i) Cl₂ and SO₂ and ii) sulfuryl chloride (SO₂Cl₂).

In the Cl₂/SO₂ chlorosulfonation process, a solvent mixture of carbon tetrachloride and chloroform is introduced to a reactor having a condenser and pressure control. Next, a quantity of polyolefin base polymer is added to the reactor. Optionally, more than one polyolefin base polymer may be added to the reactor so as to result in a blend of chlorosulfonated polyolefin polymers. For some end use applications, a blend of 2 or more different (e.g. different comonomers, different molecular weight distributions, etc.) chlorosulfonated polymers may be preferable. Any moisture in the reactor may optionally be removed by either 1) pulling a vacuum on the reactor, thus flashing an azeotrope of solvent and water from the reactor, or 2) addition of a small amount of a chemical moisture scavenger (e.g. thionyl chloride or acetyl chloride). An azo initiator (e.g. Vazo® 52 available from DuPont) is introduced and the reactor purged with an inert gas (e.g. nitrogen) to remove oxygen.

The reactor is heated to about 50° to 100° C. (preferably 55° to 85° C.) to dissolve all of the polyolefin base polymer. After adjusting the temperature of the solution to between 50° and 75° C. (preferably 55° to 60° C.), without precipitating the polyolefin base polymer, chlorine gas, sulfur dioxide and additional initiator is introduced to the reactor. When a desired level of chlorosulfonation has occurred, the reaction mass is degassed with nitrogen, followed by application of a vacuum. Optionally, an epoxide, e.g. Epon® 828 (available from Hexion Specialty Chemicals), is added to stabilize the product. Also optionally, an antioxidant, e.g. Irganox® 1010 (available from Ciba Specialty Chemicals) is added to protect the polymer during isolation and storage.

The SO₂Cl₂ chlorosulfonation process differs from the Cl₂/SO₂ process in that sulfuryl chloride and an optional amine activator (e.g. pyridine, 1,8-diazabicyclo[5.4.0]undec-7-ene (DBU), etc.), rather than chlorine gas and sulfur dioxide, is employed to chlorosulfonate the polyolefin base polymer.

The polyolefin base polymers employed in the process of this invention include various ethylene/alpha-olefin copolymers. This includes traditional Ziegler-Natta LLDPE and metallocene derived ethylene alpha-olefin copolymers. The alpha-olefin may be any unbranched alpha-olefin containing between 3 and 20 carbon atoms. Octene-1, butene-1 and propylene are preferred alpha-olefins. The copolymers may be semi-crystalline or amorphous. Semi-crystalline copolymers are preferred because they are easier to handle.

Chlorosulfonated polyolefins made by the process of the invention may be compounded with curatives and other additives typically employed in chlorosulfonated polyolefin compositions.

Chlorosulfonated polyolefins made by the process of this invention may also be converted to sulfonate derivatives for use in other end use applications.

Useful curatives include bismaleimide, peroxides (e.g. Di-Cup®), sulfur donors (e.g. dithiocarbamyl polysufides) and metal oxides (e.g. MgO).

Examples of additives suitable for use in the compositions include, but are not limited to i) fillers; ii) plasticizers; iii) process aids; iv) acid acceptors; v) antioxidants; and vi) antiozonants.

### EXAMPLES

### Test Methods

Weight percent Cl and S incorporated in chlorosulfonated copolymers was measured by the Schoniger combustion method (J. C. Torr and G. J. Kallos, American Industrial Association J. July, 419 (1974) and A. M. MacDonald, Analyst, v86, 1018 (1961)).

### Example 1

A chlorosulfonated ethylene/octene-1 copolymer blend (CSM 1) was prepared by the chlorine gas/SO₂ procedure. 80 pounds (36.3 kg) of a solvent consisting of 90 weight percent (wt. %) carbon tetrachloride and 10 wt. % chloroform was added to a 10-gallon (37.9 liter), jacketed reaction vessel fitted with a condenser and pressure control. 1.25 pounds (0.567 kg) of ethylene/octene-1 copolymer (Engage® 8150, available from The Dow Chemical Co., having a melt index of 0.5 g/10 min. and a density of 0.868 g/cm³) and 4.75 pounds (2.15 kg) of ethylene/octene-1 copolymer having a melt index of 30 g/10 minutes and density of 0.870 g/cm³ (Engage® 8407, available from The Dow Chemical Co.) was then added to the reactor. Next, 17 g of thionyl chloride was added to remove moisture from the reactor contents. 2 g of Vazo® 52 initiator (2,2′-azobis(2,4-dimethylpentane nitrile), available from DuPont) dissolved in 10 ml of chloroform was then added to the reactor. The reactor was closed and sparged with nitrogen at about 10 liters/minute for 20 minutes to remove air. The reaction mass was sparged with sulfur dioxide and then pressured to 2 psig (13.8 kPa) with sulfur dioxide and increased to 20 psig (138 kPa) with nitrogen. The reactor content was then heated, with steam on the reactor jacket, to 85° C. for 30 minutes to dissolve the polymer. The reaction temperature was then lowered to 55°-60° C. using a steam water mixture through the reactor jacket. While maintaining the reaction temperature at 55°-60° C., a 0.7 wt. % solution Vazo® 52 initiator in chloroform was added continuously at a rate of 200 ml per hour throughout the reaction. Chlorine gas was then sparged into the reactor at a rate of 0.1 lbs/hour (45.3 g/hour) and sulfur dioxide was added at a rate of 2 lbs/hour (0.91 kg/hour) until 0.130 lbs (59 kg) of chlorine and 2.6 lbs (1.2 kg) of sulfur dioxide had been added, maintaining a reaction temperature of 55°-60° C. throughout. A sample of reactor solution was taken for analysis. The product contained 1.06 wt. % sulfur and 1.87 wt. % chlorine. The reaction mass was degassed by sparging a low flow of nitrogen into the reactor for 5 minutes, followed by vacuum for 30 minutes. The reaction mass was stabilized by addition of 18 g of Epon® 828 (a condensation product of epichlorohydrin and bisphenol A, available from Hexion Specialty Chemicals) and 0.9 g Irganox® 1010 (available from Ciba Specialty Chemicals). The chlorosulfonated ethylene/alpha-olefin copolymer blend was isolated by slowly pouring the solution onto a heated drum dryer where the solvent was flashed off leaving a thin film of polymer which was removed from the drum using a doctor blade.

### Example 2

Another chlorosulfonated ethylene/alpha olefin copolymer blend (CSM 2) was prepared by the sulfuryl chloride procedure. 50 pounds (22.7 kg) of a solvent consisting of 90 wt. % carbon tetrachloride and 10 wt % chloroform was added to a 10-gallon (37.9 L), jacketed reaction vessel fitted with a condenser and pressure control. 2.4 pounds (1.09 kg) of an ethylene/octene-1 copolymer (Engage® 8407, available from The Dow Chemical Co., having a melt index of 30 g/10 min. and a density of 0.87 g/cm³) and 0.6 pounds (0.272 kg) of ethylene/butene-1 copolymer (Engage® 7380, available from The Dow Chemical Co., having a melt index of 0.3 g/10 minutes and density of 0.870 g/cm³ was then added to the reactor. The reactor was then closed and heated to 80° C. and 10 pounds (4.5 kg) of solvent was flashed overhead and collected to remove trace moisture from the reactor. Next, 2 g of Vazo® 52 initiator (2,2′-azobis(2,4-dimethylpentane nitrile) dissolved 10 ml of chloroform was added to the reactor followed by 3 ml of DBU (1,8-diazabicyclo[5.4.0]undec-7-ene). The reactor was closed and sparged with nitrogen at about 10 liters/minute for 10 minutes to remove air. The reaction mass was sparged with sulfur dioxide and then pressured to 1 psig (6.8 kPa) with sulfur dioxide and then increased to 10 psig (68 kPa) with nitrogen. The reactor content was then heated, with steam on the reactor jacket, to 85° C. for 30 minutes to ensure dissolution of the polymer. The reaction mixture was then lowered to 50°-55° C. using a steam water mixture through the reactor jacket. While maintaining the reaction temperature at 50°-53° C., a 1 wt. % solution of Vazo® 52 in chloroform was added continuously at a rate of 200 ml/hour, throughout the reaction. 100 ml of sulfuryl chloride was added at a rate of 40 ml/minute. Reaction was indicated by the evolution of byproduct hydrogen chloride and excess sulfur dioxide. After 30 minutes, the gas evolution ceased indicating that the reaction was complete. A sample from the reaction was found to contain 0.97 wt. % combined sulfur and 1.98 wt. % combined chlorine. The solution temperature was increased to 90° C. and the pressure setting to 20 Psig (136 kPa). Pressure was then reduced to atmospheric to remove residual byproduct gasses. The reaction was stabilized by addition of 12 g of Epon® 828 (a condensation product of epichlorohydrin and bisphenol A, available from Hexion Specialty Chemicals) and 6.8 g of Irganox® 1010 (available from Ciba Specialty Chemicals). The chlorosulfonated ethylene/alpha-olefin copolymer was isolated by pouring the solution onto a heated drum dryer where the solvent was flashed off leaving a thin film of polymer which was removed from the drum using a doctor blade.

### Example 3

A chlorosulfonated ethylene/alpha-olefin polymer (CSM 3) was prepared by the sulfuryl chloride procedure. 40 pounds (18.2 kg) of a solvent consisting of 90% wt. carbon tetrachloride and 10% wt. chloroform was added to a 10 gallon (38 L) jacketed reaction vessel fitted with a condenser and pressure control valve. 4.0 pounds (1.82 kg) of an ethylene/octene-1 copolymer ( Engage® 8407, available from The Dow Chemical Co.) having a melt index of 30 g/10 min. and a density of 0.87 g/cm³ was then added to the reactor. Next 2 g of Vazo® 52 initiator, dissolved in 10 ml of chloroform, was added to the reactor followed by 3 ml of DBU. The reactor was closed and heated to 70° C. The reaction mass was then sparged with sulfur dioxide and then pressured to 5 psig (34.5 kPa) with sulfur dioxide and increased to 20 psig (138 Pa) with nitrogen. The polymer solution temperature was then lowered to 65° C. using a steam water mixture through the reactor jacket. While maintaining the reaction temperature at 65° C., a 1 wt. % solution of Vazo® 52 in chloroform was added continuously at a rate of 3.33 ml/min. throughout the reaction. 150 ml of sulfuryl chloride was then added at a rate of 40 ml/min. 3.5 minutes after all of the sulfuryl chloride had been added, the vigorous reaction began as indicated by opening of the pressure control valve. After 21 minutes, the pressure control valve closed indicating that reaction was completed. A sample from the reaction was found to contain 1.12 wt. % sulfur and 3.95 wt. % chlorine. The reactor temperature was increased to 90° C. and the pressure was reduced to atmospheric to remove dissolved byproduct gasses. The polymer was stabilized by addition of 16 g of Epon® 828 (a condensation product of epichlorohydrin and bisphenol A, available from Hexion Specialty Chemicals) and was isolated from solution by boiling on two steam heated drums and doctored as a film.

### Example 4

Another chlorosulfonated polyolefin (CSM 4) was made using the procedure as in Example 3, except that 2.5 lbs (1.14 kg) of ethylene/butene-1 copolymer (Engage® 7380 from Dow Chemical Co), having a melt index of 0.3 g/10 min. and a density of 0.87 g/cm³ was employed. A total of 75 ml of sulfuryl chloride was used as a chlorosulfonating agent. A sample from the reaction was found to contain 1.08 wt. % combined sulfur and 4.0 wt. % combined chlorine. The reactor temperature was increased to 90° C. and the pressure was reduced to atmospheric to remove dissolved byproduct gasses. The polymer was stabilized by addition of 16 g of Epon® 828 (a condensation product of epichlorohydrin and bisphenol A, available from Hexion Specialty Chemicals) and the polymer was isolated from solution by boiling on two steam heated drums and doctored as a film.

### Example 5

Another chlorosulfonated polyolefin (CSM 5) was made using the procedure as in Example 1, except that 2 lbs (0.908 kg) ethylene-propylene copolymer (Vistalon® V722 from the Exxon-Mobil Corporation) having a melt index of 1.0 g/10 min. and ethylene content of 72 wt. %, was employed. A total of 0.17 (0.08 kg) pounds of chlorine gas and 2.0 pounds (0.908 kg) sulfur dioxide was used as a chlorosulfonating agent. The polymer was stabilized by addition of 10 g of Epon® 828 (a condensation product of epichlorohydrin and bisphenol A, available from Hexion Specialty. The polymer was isolated from solution by boiling on two steam heated drums and doctored as a film. The isolated dry polymer was analyzed as 2.7 wt. % chlorine and 1.44 wt. % sulfur by the Schoniger procedure.

### Comparative Example A

A comparative chlorosulfonated ethylene/propylene copolymer was prepared by using the chlorine gas/SO₂ procedure, except that the chlorosulfonation was run at 85° C., i.e. above the 75° C. maximum temperature of the process of the invention. The resulting copolymer only contained 0.21 wt. % S.

40 pounds (18.2 kg) of solvent consisting of 92 wt. % carbon tetrachloride and 8 wt. % chloroform was added to a 10 gallon (38 L) jacketed reaction vessel fitted with an agitator, a condenser and pressure control. 1,226 g of an ethylene/propylene polymer (Tafmer® P0080K, available from Mitsui Chemicals, Inc., having a melt flow rate @230° C. of 40 g/10 minute (min.) and a density of 870 g/cm³) and 136 g of an ethylene/propylene copolymer (Tafmer® P 0680, available from Mitsui Chemicals, Inc., having a melt flow rate @230° C. of 0.5 g/10 min. and a density of 870 g/cm ) was added to the solvent filled reactor. The reaction vessel was sparged with nitrogen at 10 liters/minute, atmospheric pressure, for approximately 20 minutes (with agitation) to remove air. After sparging, the nitrogen flow was stopped and the reactor pressure controller was set at 20 psig (138 kPa). The reactor was heated with jacket steam to 85° C. and maintained at that temperature for 30 minutes (with agitation) to completely dissolve the polymer. Maintaining the reactor pressure controller at 20 psig (138 kPa), the reactor was pressured to 2 psig (13.8 kPa) with sulfur dioxide and then with N₂ to 20 psig (138 kPa). While maintaining reactor temperature at 85° C. throughout the reaction, a 0.7 wt. % solution of Vazo® 52 initiator in chloroform was added at a rate of 200 ml/hour throughout the reaction. After ten minutes of initiator addition, chlorine gas was then sparged into the reactor at a rate of 100 g per hour and sulfur dioxide addition was continued at 200 g/hour until a total of 50 g of chlorine gas had been added. A small sample of the reaction solution was taken and the chlorosulfonated polymer was isolated and dried. The product was found to contain 2.76 wt. % chlorine and 0.21 wt. % sulfur. The reactor pressure was reduced to atmospheric pressure to partially remove dissolved gaseous byproducts. Sparging with nitrogen gas at a rate of 10 liters/minute was conducted for 15 minutes to further remove byproducts. The reaction mass was then stabilized by addition of 10 g of Epon® 828.

### Example 6

Another chlorosulfonated polyolefin sample was made using the same base resins and procedure as in Comparative Example A, except that temperatures were maintained within the limits of the process of this invention. Reactor content was maintained at 85° C. for 30 minutes in order to dissolve the polymer and then the temperature was lowered to 75° C. and was maintained at 75° C. throughout the chlorosulfonation reaction. A small sample of the reaction solution was taken and the chlorosulfonated polymer isolated and dried. The product was found to contain 2.55 wt. % chlorine and 0.48 wt. % sulfur.

### Example 7

Another chlorosulfonated polyolefin sample was made using the same base resins and procedure as in Comparative Example A, except that temperatures were maintained within the limits of the process of this invention. Reactor content was maintained at 85° C. for 30 minutes in order to dissolve the polymer and then the temperature was lowered to 59° C. and was maintained at 59° C. throughout reaction. A small sample of the reaction solution was taken and the chlorosulfonated polymer isolated and dried. The product was found to contain 2.08 wt. % chlorine and 1.20 wt. % sulfur.

What is claimed is:

1. A process for the manufacture of chlorosulfonated polyolefins comprising 0.5 to 10 weight percent chlorine and 0.25 to 5 weight percent sulfur, said process comprising:
A) dissolving at least one polyolefin base polymer in a solvent at a temperature between 50° and 100° C. to form a solution;
B) adjusting the temperature of the solution to between 50° and 75° C. without precipitating said polyolefin; and
C) adding a chlorosulfonation agent and initiator to said solution, while maintaining said temperature between 50° and 75° C. to form at least one chlorosulfonated polyolefin comprising 0.5 to 10 weight percent chlorine and 0.25 to 5 weight percent sulfur.

2. A process for the manufacture of chlorosulfonated polyolefins of claim 1 wherein said chlorosulfonation agent is chlorine gas and sulfur dioxide.

3. A process for the manufacture of chlorosulfonated polyolefins of claim 1 wherein said chlorosulfonation agent is sulfuryl chloride.

4. A process for the manufacture of chlorosulfonated polyolefins of claim 1 wherein said polyolefin base polymer is a copolymer of ethylene and a C₃ to C₂₀ unbranched alpha-olefin.

5. A process for the manufacture of chlorosulfonated polyolefins of claim 4 wherein said alpha-olefin is selected from the group consisting of octene-1, butene-1 and propylene.

6. A process for the manufacture of chlorosulfonated polyolefins of claim 5 wherein said alpha-olefin is octene-1.

7. A process for the manufacture of chlorosulfonated polyolefins of claim 5 wherein said alpha-olefin is butene-1.

8. A process for the manufacture of chlorosulfonated polyolefins of claim 5 wherein said alpha-olefin is propylene.

9. A process for the manufacture of chlorosulfonated polyolefins of claim 1 further comprising the step of removing moisture from said solution prior to adding said chlorosulfonation agent and said initiator to said solution.

10. A process for the manufacture of chlorosulfonated polyolefins of claim 9 wherein said moisture removal is by pulling a vacuum on said reactor.

11. A process for the manufacture of chlorosulfonated polyolefins of claim 9 wherein said moisture removal is by addition of a chemical moisture scavenger to said solution.

12. A process for the manufacture of chlorosulfonated polyolefins of claim 1 wherein at least two different polyolefin base polymers are dissolved in A).
